(19) United States
(12) Patent Application Publication
(10) Pub. No.: US 2025/0214184 A1
(43) Pub. Date: Jul. 3, 2025

(54) SCREWING APPARATUS

(71) Applicant: Weber Schraubautomaten GmbH, Wolfratshausen (DE)

(72) Inventors: Sebastian BÖCK, Holzhausen (DE); Franz KROLL, Egling (DE); Robert STÜTZER, Wolfratshausen (DE)

(21) Appl. No.: 18/848,595

(22) PCT Filed: Mar. 10, 2023
(86) PCT No.: PCT/EP2023/056142

§ 371 Date: Sep. 19, 2024

(30) Foreign Application Priority Data
Mar. 22, 2022 (DE) 102022106710.6

(51) Int. Cl. B23P 19/06; B25B 21/00

(52) U.S. Cl. CPC B23P 19/06; B25B 21/00

(57) ABSTRACT

The invention relates to a screwing apparatus for setting a screw. The screwing apparatus comprises a rotary drive for rotationally driving the screw, a feed drive for generating an axial feed force on the screw, and a shaft-hub unit comprising a drive shaft, which has a non-circular cross-section, and a hub rotationally fixedly connected to the drive shaft. The drive shaft and the hub serve to transmit a torque provided by the rotary drive. In this respect, the drive shaft and the hub are axially displaceable relative to one another within a first torque load range to allow an axial feed movement of the screw relative to the rotary drive. To reduce wear at the shaft-hub unit, a compensating coupling is provided that allows a joint axial movement of the shaft and the hub relative to the rotary drive when a torque load exceeds the first torque load range.

The invention relates to a screwing apparatus and to the use of such a screwing apparatus.

It is known from the prior art to insert thread-forming screws, for example flow-drilling screws, into a component by means of a screwing apparatus. Such a screwing apparatus has a rotary drive to rotationally drive a drive torque transmission unit of the screwing apparatus, said drive torque transmission unit being configured in the form of drive shafts. The drive torque transmission unit is coupled at the end remote from the rotary drive to a bit that engages into an engagement feature of the screw to set the screw into rotation. Furthermore, such a screwing apparatus has a feed drive to move the bit and thus the screw in the feed direction, i.e. in the axial direction.

So that the bit and thus the screw can be moved in the axial direction relative to the rotary drive and the drive torque can simultaneously be transmitted from the rotary drive via the drive torque transmission unit to the bit and the screw, known screwing apparatus have a drive torque transmission unit with a shaft-hub connection. This shaft-hub connection makes it possible for a section of the drive torque transmission unit close to the screw to be moved in the axial direction relative to a section of the drive torque transmission unit close to the rotary drive.

The section of the drive torque transmission unit close to the screw can hereby perform a feed movement, which is caused by the feed drive, under load, while the section of the drive torque transmission unit close to the rotary drive and a rotor of the rotary drive fixedly connected to the section of the drive torque transmission unit close to the rotary drive do not perform this feed movement. In other words, the shaft-hub connection makes it possible that the drive torque transmission unit can be variable with respect to its effective length during the screwing-in process and the bit and the screw can thus perform a feed movement relative to the rotary drive while the rotary drive applies a torque to the bit and screw via the drive shaft.

Known screwing apparatus have the disadvantage that the shaft-hub connection is subject to high wear. Specifically in the case of high torque loads, which occur, for example, during the thread forming when processing self-tapping screws, a high surface pressure is produced at the shaft-hub connection, whereby an axial displacement of the shaft relative to the hub causes high frictional forces between the shaft and the hub. High wear is produced at the shaft-hub connection by the high frictional forces. Furthermore, due to the high frictional forces, a powerful feed drive is required to effect the axial displacement of the shaft relative to the hub in a reliable process, which leads to higher costs for the feed drive.

A further disadvantage of known screwing apparatus is that the feed force to be generated by the feed drive is difficult to control. If the shaft-hub connection is loaded with a high torque, for example during the thread forming, a high feed force is required to overcome static friction between the shaft and the hub and to cause an axial relative movement between the shaft and the hub. As soon as this static friction is overcome, the feed force required for the axial relative movement can drop considerably. Due to the major changes in the required feed force during the screwing process, it is difficult to control the feed force.

It is an object of the present invention to provide a screwing apparatus that is designed as less prone to wear and enables a simpler control.

The object is satisfied by a screwing apparatus having the features of claim 1 and in particular in that a compensating coupling is provided that allows a joint axial movement of the shaft and the hub relative to the rotary drive when a torque load exceeds the first torque load range.

The invention is based on the idea of avoiding an actually necessary relative movement of the shaft and the hub when a high torque is applied in order to spare the shaft and the hub. For this purpose, the compensating coupling is provided that allows an axial compensation independent of a shaft-hub unit so that the shaft and the hub can jointly cover an axial distance that would correspond to a relative movement between the shaft and the hub without a compensating coupling.

The screwing apparatus serves to set a screw, i.e. to fasten a screw to a workpiece. The advantages of the screwing apparatus are particularly evident when the screwing process requires a high maximum torque. Such a high maximum torque is usually required for thread-forming screws during the thread forming, i.e. while the respective screw cuts a thread into the workpiece. Another application where a high maximum torque is usually required is the setting of screws with a coating on the thread, for example to seal or secure the screw. Normally, maximum torques of more than 4 Nm, i.e. four Newton meters, are required for these applications with a high maximum torque.

The screwing apparatus has a rotary drive for rotationally driving the screw. For this purpose, the rotary drive drives a drive torque transmission unit that extends from the rotary drive up to a bit and that has a plurality of drive shafts. The rotary drive can be configured as an electric motor.

The screwing apparatus furthermore has a feed drive that produces an axial feed during the screwing process. The feed drive can be pneumatic or electric, for example.

The screwing apparatus comprises the aforementioned shaft-hub unit. The shaft-hub unit is part of the drive torque transmission unit that serves to transmit a torque from the rotary drive to the bit. The shaft-hub unit comprises a drive shaft and a corresponding hub. The drive shaft engages into the hub in a form-fitting manner to transmit the torque from the drive shaft to the hub or from the hub to the drive shaft. For this purpose, the drive shaft has a non-circular outer periphery and the hub has an axial opening having a, in particular corresponding, non-circular inner periphery.

The drive shaft and the hub, i.e. the shaft-hub unit, are axially displaceable relative to one another within a first torque load range to allow an axial feed movement of the screw relative to the rotary drive. In other words, the shaft-hub unit enables an axial relative movement between the drive shaft and the hub at a torque load below a threshold value, for example 4 Nm, so that a section of the drive torque transmission unit close to the screw can perform a feed movement, while a section of the drive torque transmission unit close to the rotary drive does not perform this feed movement, but is instead arranged in a fixed position in the axial direction. This first torque load range should be selected so that, at most, little wear occurs at the shaft-hub unit in this range.

Above the first torque load range, the friction between the shaft and the hub can lead to increased wear or the axial displaceability relative to one another can only be given under high forces. The compensating coupling is active in this region so that no axial relative movement between the shaft and the hub is necessary.

Advantageous embodiments of the invention can be seen from the dependent claims, from the description and from the drawings.

According to one embodiment, the compensating coupling is configured to transmit a torque of the rotary drive to the shaft-hub unit. In other words, the compensating coupling can form a section of the drive torque transmission unit that connects the rotary drive to the bit. The screwing apparatus can hereby be particularly compact.

According to a particularly simple design of the compensating coupling, the compensating coupling comprises a guide element and a compensating element axially movably supported at, in particular in, the guide element. The guide element and the compensating element are preferably made of an inelastic material, e.g. a steel alloy. The guide element can be directly or indirectly connected to a motor shaft of the rotary drive. In this case, the compensating element can be directly or indirectly connected to the drive shaft. Alternatively thereto, the guide element can be directly or indirectly connected to the drive shaft and the compensating element can be directly or indirectly connected to the motor shaft.

According to an embodiment, at least one rolling body is provided at the compensating element. The rolling body can have an outer peripheral surface that extends centrally about a rolling axis and that serves as a roll-off surface. The at least one rolling body can be configured to roll off at the guide element during an axial relative movement between the guide element and the compensating element. Friction between the guide element and the compensating element is hereby reduced. Preferably, the friction between the guide element and the compensating element is substantially limited to rolling friction.

Alternatively to arranging the at least one rolling body at the compensating element, the at least one rolling body can be arranged at the guide element. This at least one rolling body can also have an outer peripheral surface extending centrally about a rolling axis and serving as a roll-off surface. During a relative movement between the guide element and the compensating element, the rolling body arranged at the guide element can roll off at the compensating element.

According to one embodiment, the at least one rolling body is configured to transmit a torque of the rotary drive to the shaft-hub unit. The at least one rolling body can thus have a dual function: On the one hand, the at least one rolling body enables a low-friction relative movement between the guide element and the compensating element. On the other hand, the at least one rolling body serves to transmit the torque provided by the rotary drive from the guide element to the compensating element or from the compensating element to the guide element.

According to one embodiment, the at least one rolling body has an axis of rotation extending in a radial direction. The at least one rolling body can project in the radial direction from the rest of the compensating element. In this respect, the at least one rolling body can project into a groove extending in the axial direction in the guide element. A torque transmission between the guide element and the compensating element can hereby take place in a particularly simple manner.

The at least one rolling body preferably has a peripheral surface that contacts a roll-off surface, which extends in an axial direction, under load. The roll-off surface can have a length in the axial direction that corresponds approximately to a groove path of the screw to be inserted. Such a groove path can be 15 mm long, for example. The roll-off surface can be configured as a side surface of the groove extending in the axial direction. The roll-off surface, in particular the groove, can be formed at the guide element.

According to one embodiment, a plurality of rolling bodies, for example three rolling bodies, having one or more of the aforementioned or following features can be provided.

The compensating coupling preferably comprises a spring element. The spring element can act between the compensating element and the guide element to apply an axial return force to the compensating element that returns the compensating element to an initial position when the torque load on the shaft-hub connection falls below a threshold value. The spring element can be tensioned by a relative movement between the compensating element and the guide element when a torque load exceeds the first torque load range, i.e. in a second torque load range. The spring element is preferably configured as a spiral spring, in particular as a spiral compression spring. The spring element preferably extends in the axial direction and/or in the peripheral direction around the compensating element.

According to one embodiment, the compensating coupling comprises a damping element to dampen an axial relative movement between the compensating element and the guide element.

The damping element can be configured to dampen a return movement of the compensating element that is induced by a return force of the spring element. It can hereby be ensured that an abutting movement of the compensating element at an end face of the guide element does not cause any disturbing noises.

It has been found that the shaft-hub connection has a particularly long service life if the compensating coupling is configured to allow the joint axial movement of the shaft and the hub relative to the rotary drive from a release force of between 100 N and 400 N. Specifically, the compensating coupling can be configured to allow the joint axial movement of the shaft and the hub relative to the rotary drive from a release force of between 150 N and 250 N. In other words, the compensating coupling can become active when a minimum force of between 150 N and 250 N acts on the coupling.

According to one embodiment, the compensating element is fixedly connected to the drive shaft of the shaft-hub unit. In this context, “fixedly connected” means axially and rotationally immovably fixed to one another. The guide element can be fixedly connected to a motor shaft of the rotary drive.

The compensating element is preferably connected to the drive shaft of the shaft-hub unit by means of a clamping connection. Alternatively, the compensating element can be connected to the drive shaft of the shaft-hub unit by means of a form-fitting connection, for example by means of a pin. The guide element of the compensating coupling can be connected to the motor shaft of the rotary drive by means of a clamping connection. Alternatively, the guide element can be connected to the motor shaft of the rotary drive by means of a form-fitting connection, for example by means of a pin.

According to one embodiment, the drive shaft of the shaft-hub unit can be configured as a spline shaft, in particular a multiple spline shaft.

The invention furthermore relates to a use of a screwing apparatus according to at least one of the features mentioned above or below for screwing thread-forming screws and/or screws with a maximum screw-in torque of more than 4 Nm.

The invention will be described in the following with reference to a purely exemplary embodiment and to the enclosed drawings. There are shown:

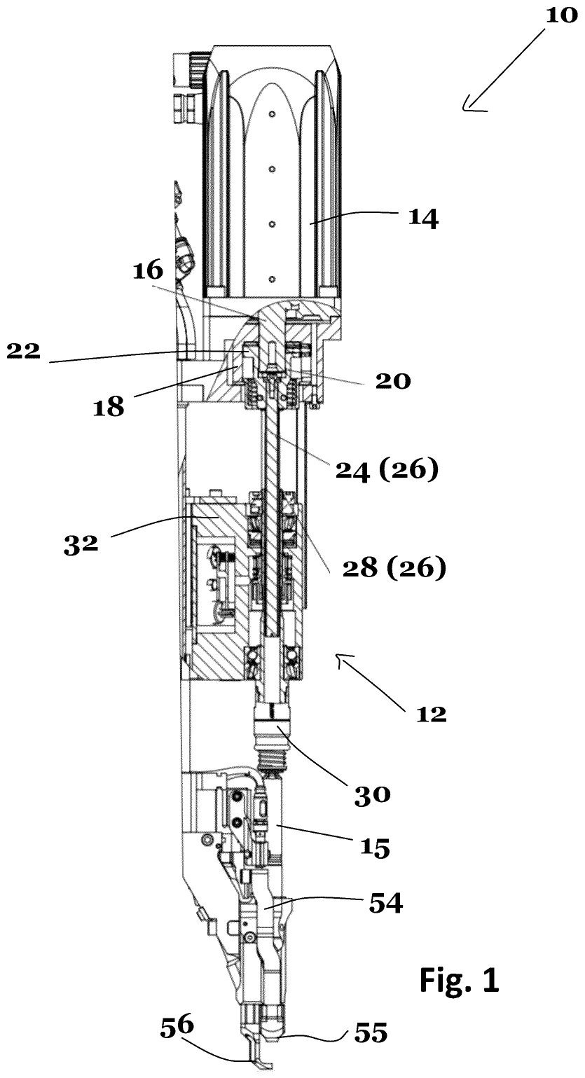

FIG. 1 a partly sectioned side view of a screwing apparatus according to the invention;

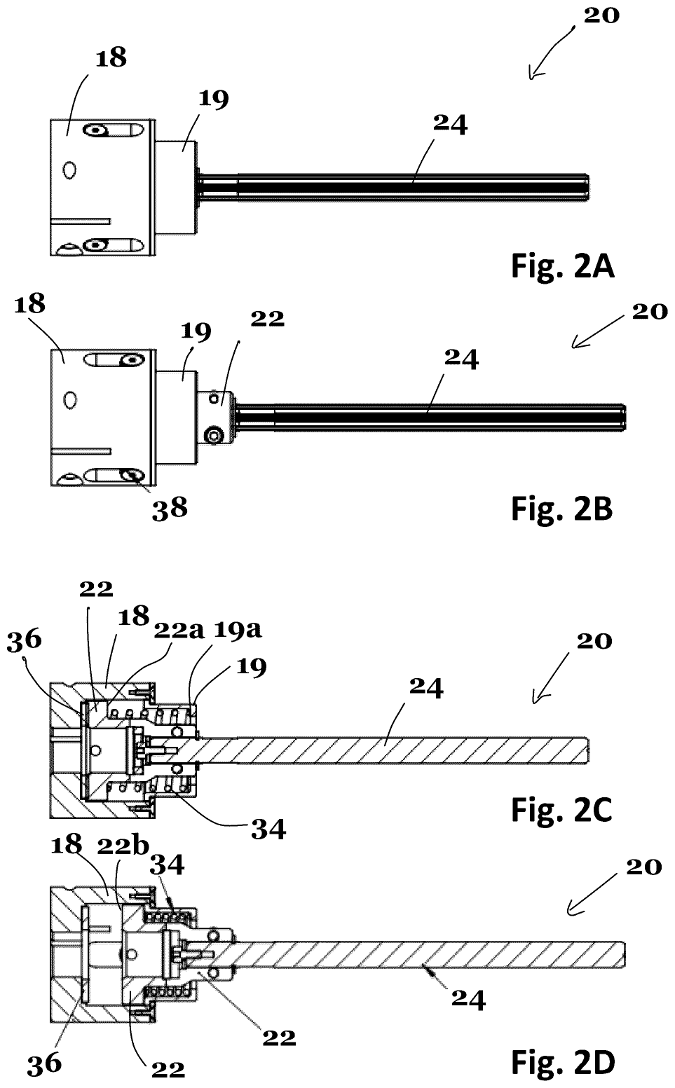

FIG. 2A a side view of a compensating coupling of the screwing apparatus of FIG. 1 in a base position;

FIG. 2B a side view of the compensating coupling of FIG. 2A in an end position;

FIG. 2C a longitudinal section of the compensating coupling of FIG. 2A;

FIG. 2D a longitudinal section of the compensating coupling of FIG. 2B;

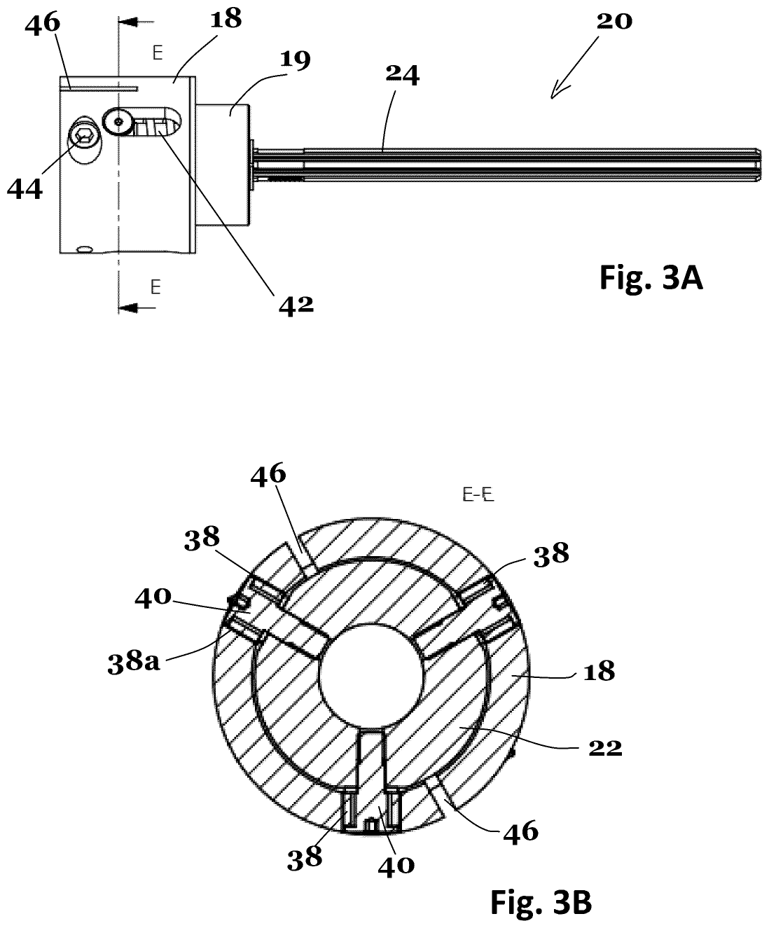

FIG. 3A a further side view of the compensating coupling of FIG. 2A; and

FIG. 3B a cross-section of the compensating coupling along the sectional plane A-A of FIG. 3A;

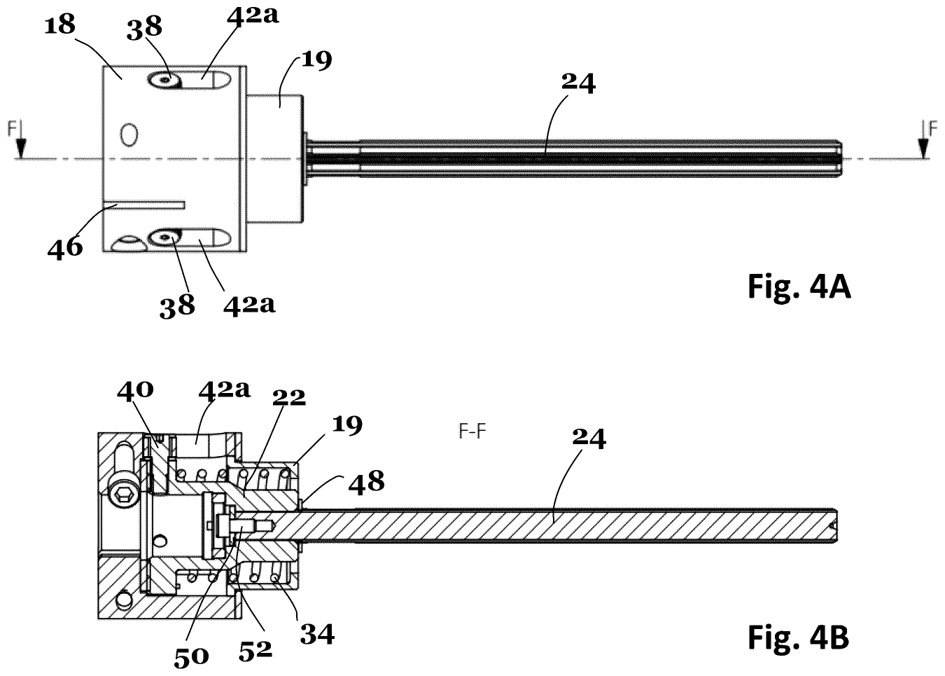

FIG. 4A a further side view of the compensating coupling of FIG. 2A; and

FIG. 4B a further longitudinal section of the compensating coupling along the sectional plane F-F of FIG. 4A.

FIG. 1 shows a screwing apparatus 10. The screwing apparatus 10 comprises a drive torque transmission unit 12 that extends from a rotary drive 14, which is configured as an electric motor in the present example, up to a screw tool or a bit 15. The drive torque transmission unit 12 comprises a motor shaft 16 that is fixedly connected to an input element 18 of a compensating coupling 20, for example by means of a clamping connection. The input element 18 is a tubular guide element 18. A compensating element 22 of the compensating coupling 20 is axially displaceably supported, i.e. vertically displaceably supported in FIG. 1, in the guide element 18. The compensating element 22 serves as the output element of the compensating coupling 20 and is fixedly connected, for example by means of a clamping connection, to a drive shaft 24 of a shaft-hub unit 26. The drive shaft 24 is configured as a multiple spline shaft. The drive shaft 24 is coupled to a hub 28 of the shaft-hub unit 26. The coupling between the drive shaft 24 and the hub 28 makes it possible that the hub 28 can move in an axial direction, i.e. in a vertical direction in FIG. 1, relative to the drive shaft 24 while a torque is applied to the drive torque transmission unit 12 in a first torque load range. The hub 28 is coupled to a receiver 30 for the bit 15.

The screwing apparatus 10 further comprises a feed drive 32 (not completely shown). The feed drive 32 is configured as a pneumatic linear drive and is coupled to the hub 28 of the shaft-hub unit 26 to move the hub 28 and the receiver 30, which form a section 34 of the drive torque transmission unit 12 close to the screw, in an axial direction relative to the rotary drive 14. In the first torque load range, for example while the screw is drilling a hole into the workpiece, the feed drive 32 moves the hub 28, the receiver 30, the bit 15 fastened to the receiver 30 and the screw in the axial direction, while the drive shaft 24, the compensating coupling 20 and the motor shaft 16, i.e. a section of the drive torque transmission unit 12 close to the drive, do not make a movement in the axial direction.

However, if, for example, while the screw is forming a thread in the workpiece, the torque applied to the drive torque transmission unit 12 exceeds the first torque load range and is thus in a second torque load range, the compensating coupling 20 becomes active. This means that the compensating coupling 20 leaves its base position (see FIGS. 2A and 2C) and the compensating element 22 performs a compensating movement, as can be seen from the comparison of FIGS. 2A and 2C with FIGS. 2B and 2D.

As can be seen in FIG. 2C, in the base position, the compensating element 22 is preloaded by a spring element 34 in the form of a spiral compression spring into a base position. For this purpose, the spring element 34 acts on an end face 22a of the compensating element 22 that is oriented towards the screw. The spring element 34 extends between the end face 22a of the compensating element 22 that is oriented towards the screw and an end face 19a of a cap 19, said cap being connected to the guide element 18, that faces the end face 22a. The spring element 34 preloads the guide element 22 in the base position (see FIG. 2C) against a damping element 36 so that an end face 22b remote from the screw (see FIG. 2D) contacts the damping element 36.

When the compensating coupling is active, the compensating element 22 moves in an axial direction relative to the guide element 18. The spring element 34 is compressed in so doing (see FIG. 2D). Due to this compensating movement in the compensating coupling 20, the drive shaft 24 can move along with the hub 28 so that wear between the drive shaft 24 and the hub 28 can be avoided at high torques.

To make the relative movement between the compensating element 22 and the guide element 18 as low-friction as possible, a plurality of, here three, rolling bodies 38 are provided at the compensating element 22, as can be seen in FIG. 3B, that roll off at the guide element 18 during an axial relative movement between the guide element 18 and the compensating element 22. The rolling bodies 38 are rotatably supported at axles 40 extending in a radial direction. Slide bearings or needle bearings can be provided for this purpose. The rolling bodies 38 are each arranged in grooves 42 extending in the axial direction (see FIG. 3A). When a torque is applied to the drive torque transmission unit 12, an outer peripheral surface 38a of the rolling bodies 38 is in contact with one of the side surfaces 42a (see FIG. 4A) to transmit the torque from the guide element 18 to the compensating element 22. It is hereby possible to transmit a torque from the guide element 18 to the compensating element 22 during a compensating movement of the compensating element 22 relative to the guide element 18.

As can in particular be seen in FIG. 3A, the guide element 18 has a clamping screw 44 and a clamping groove 46 extending in the axial direction. The clamping screw 44 and the clamping groove 46 form a clamping unit that enables the guide element 18 to be coupled to the motor shaft 16 by means of a clamping connection.

A possible coupling between the compensating element 22 and the drive shaft 24 is shown in FIG. 4B. The coupling shown is a form-fitting coupling. For this purpose, a securing ring 48 is attached to the drive shaft 24 and blocks an axial movement of the compensating element 22 in the direction of the screw. Furthermore, a washer 50 is provided that is fixed to a screw 52, which is screwed into the drive shaft 24 at the end face, such that the washer 50 blocks a movement of the drive shaft 24 relative to the compensating element 22 in the direction of the screw. Furthermore, the compensating element 22 is fastened to the drive shaft 24 by means of an interference fit. Thus, the compensating element 22 and the drive shaft 24 are also coupled to one another in a force-fitting manner. Alternatively, the compensating element 22 can be coupled to the drive shaft 24 only in a form-fitting manner or only in a force-fitting manner. However, it is important here that a torque and an axial force can be transmitted via the coupling.

The screwing apparatus 10 (see FIG. 1) furthermore comprises an automatic feed 54 for screws that feeds the screws, in particular by means of compressed air, to a receiver 55. The screwing apparatus 10 furthermore comprises a down-holding device 56 that is configured to fix the workpiece, for example a sheet metal.

### REFERENCE NUMERAL LIST

10 screwing apparatus
12 drive torque transmission unit
14 rotary drive
15 bit
16 motor shaft
18 guide element
19 cap
39A end face
20 compensating coupling
22 compensating element
22a end face
22b end face
24 drive shaft
26 shaft-hub unit
28 hub
30 receiver
32 feed drive
34 spring element
36 damping element
38 rolling body
38a peripheral surface
40 axle
42 groove
42a roll-off surface
44 clamping screw
46 clamping groove
48 securing ring
50 washer
52 screw
54 automatic feed
55 receiver
56 down-holding device

1-15. (canceled)

16. A screwing apparatus for setting a screw, said screwing apparatus comprising:
a rotary drive for rotationally driving the screw,
a feed drive for generating an axial feed force on the screw,
a shaft-hub unit comprising a drive shaft, which has a non-circular cross-section, and a hub rotationally fixedly connected to the drive shaft,
wherein the drive shaft and the hub serve to transmit a torque provided by the rotary drive, and
wherein the drive shaft and the hub are axially displaceable relative to one another within a first torque load range to allow an axial feed movement of the screw relative to the rotary drive,
wherein a compensating coupling is provided that allows a joint axial movement of the drive shaft and the hub relative to the rotary drive when a torque load exceeds the first torque load range.

17. The screwing apparatus according to claim 16,
wherein the compensating coupling is configured to transmit a torque of the rotary drive to the shaft-hub unit.

18. The screwing apparatus according to claim 16,
wherein the compensating coupling has a guide element and a compensating element axially movably supported at the guide element.

19. The screwing apparatus according to claim 18,
wherein at least one rolling body is provided at the compensating element and rolls off at the guide element during an axial relative movement between the guide element and the compensating element.

20. The screwing apparatus according to claim 19,
wherein the at least one rolling body is configured to transmit a torque generated by the rotary drive to the shaft-hub unit.

21. The screwing apparatus according to claim 19,
wherein the at least one rolling body has an axis of rotation extending in a radial direction.

22. The screwing apparatus according to claim 19,
wherein the at least one rolling body has a peripheral surface, and
the peripheral surface contacts a roll-off surface, which extends in an axial direction, under load.

23. The screwing apparatus according to claim 18,
wherein the compensating coupling comprises a spring element, with the spring element acting between the compensating element and the guide element.

24. The screwing apparatus according to claim 18,
wherein the compensating coupling comprises a damping element to dampen an axial relative movement between the compensating element and the guide element.

25. The screwing apparatus according to claim 23,
wherein the damping element is configured to dampen a return movement of the compensating element that is induced by a return force of the spring element.

26. The screwing apparatus according to claim 16,
wherein the compensating coupling is configured to allow the joint axial movement of the drive shaft and the hub relative to the rotary drive from a release force between 100 N and 400 N.

27. The screwing apparatus according to claim 18,
wherein the compensating element is fixedly connected to the drive shaft of the shaft-hub unit.

28. The screwing apparatus according to claim 27,
wherein the compensating element is connected to the drive shaft of the shaft-hub unit by means of a clamping connection.

29. The screwing apparatus according to claim 16,
wherein the drive shaft is configured as a spline shaft.

30. Method of using a screwing apparatus, said screwing apparatus comprising:
a rotary drive for rotationally driving the screw,
a feed drive for generating an axial feed force on the screw,
a shaft-hub unit comprising a drive shaft, which has a non-circular cross-section, and a hub rotationally fixedly connected to the drive shaft,
wherein the drive shaft and the hub serve to transmit a torque provided by the rotary drive, and
wherein the drive shaft and the hub are axially displaceable relative to one another within a first torque load range to allow an axial feed movement of the screw relative to the rotary drive,
wherein a compensating coupling is provided that allows a joint axial movement of the drive shaft and the hub relative to the rotary drive when a torque load exceeds the first torque load range,
wherein the screwing apparatus is used to screw thread-forming screws and/or screws with a maximum screw-in torque of more than 4 Nm.

31. The screwing apparatus according to claim 16, wherein the screwing apparatus is configured to set a thread-forming screw and/or a screw with a maximum screw-in torque of more than 4 Nm.

32. The screwing apparatus according to claim 18,
wherein the compensating element is axially movably supported in the guide element.

33. The screwing apparatus according to claim 16,
wherein the compensating coupling is configured to allow the joint axial movement of the drive shaft and the hub relative to the rotary drive from a release force between 150 N and 250 N.

34. The screwing apparatus according to claim 29,
wherein the drive shaft is configured as a multiple spline shaft.
